(19) United States
(12) Patent Application Publication
(10) Pub. No.: US 2003/0166794 A1
(43) Pub. Date: Sep. 4, 2003

(54) Thermoplastically processable polyurethane molding material

(75) Inventors: Horst Muehlfeld, Grasellenbach (DE); Thomas Schauber, Hemsbach (DE); Erich Christoph, Obertshausen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Intier Automotive Eybl, Weinheim (DE)

(21) Appl. No.: 10/365,189

(22) Filed: Feb. 12, 2003

(30) Foreign Application Priority Data
Feb. 18, 2002 (DE) DE 102 06 839.9

(51) Int. Cl. C08F 283/04

(52) U.S. Cl. 525/453

(57) ABSTRACT

A thermoplastically processable polyurethane molding material which is composed of a blend of at least two thermoplastic polyurethane, with at least 5 percent by weight, as a component A, being composed of a thermoplastic polyurethane which is obtained by reacting one or a plurality of aliphatic polyols which have a molecular weight of 800 to 4000 g/mol and a hydroxyl number of 20 to 235 and which are selected from the group of polyadipates, polycaprolactones, polycarbonates, polytetrahydrofurans and corresponding copolymers or mixtures thereof with 1,6-hexamethylene diisocyanate and the chain-extending agent 1,6-hexanediol in an equivalent ratio of the 1,6-hexamethylene diisocyanate to the polyol of 1.5:1 to 14.0:1, the NCO index formed from the quotient, which is multiplied by 100, of the equivalent ratios of isocyanate groups to the sum of the hydroxyl groups of polyol and chain-extending agent lying within a range of 96 to 105, and 100 percent by weight of the rest, as a component B, being composed of one or a plurality of further thermoplastic polyurethane which is obtained by reacting one or a plurality of aliphatic polyols which have a molecular weight of 800 to 4000 g/mol and a hydroxyl number of 20 to 235 and which are selected from the group of polyadipates, polycaprolactones, polycarbonates, polytetrahydrofurans and corresponding copolymers or mixtures thereof with the diisocyanates: 1,6-hexamethylene diisocyanate, isophorone diisocyanate, dicyclohexylmethane diisocyanate, diphenylmethane diisocyanate and a chain-extending agent selected from the group of 1,4-butanediol, 1,5 pentanediol, 1,4-cyclohexanediol, bis(hydroxymethyl)cyclohexane, bis(hydroxyethyl)hydroquinone, polycaprolactone having a number average molecular weight of 350 to 600 g/mol and polytetrahydrofuran having a number average molecular weight of 200 to 600 g/mol in an equivalent ratio of the diisocyanate to the polyol of 1.5:1 to 14.0:1, the NCO index formed from the quotient, which is multiplied by 100, of the equivalent ratios of isocyanate groups to the sum of the hydroxyl groups of polyol and chain-extending agent lying within a range of 96 to 105.

Priority to German Patent Application No. 102 06 839.9, filed Feb. 18, 2002 and hereby incorporated by reference herein, is claimed.

### BACKGROUND INFORMATION

The present invention relates to a thermoplastically processable polyurethane molding material composed of a blend of at least two thermoplastic polyurethane.

German Patent Documents DE 26 58 136 and DE 42 03 307 describe thermoplastically processable polyurethane (TPU) which are composed of mixtures of different aliphatic polyols and 1,6-hexamethylene diisocyanate with chain-extending agents such as 1,4-butanediol. The polyurethane molding materials described there can be used, in particular, for manufacturing food packaging, but also for manufacturing films for decorative purposes. The polyurethane molding materials defined in the patents are indeed suitable in terms of their melting properties for thermoplastic processing methods and in terms of their strength level for the aforementioned applications, but have the disadvantage of cyclic oligourethane components in the polyurethane molding materials. Migration of these cyclooligourethanes can result in optical changes, for example, on the surface of films.

German Patent Document DE 199 40 014 indeed describes thermoplastic polyurethane (TPU) which are stable to light and heat, satisfy high optical requirements, and which, after an accelerated ageing test at 60° C. to 90° C., still yield molded bodies exhibiting only a small amount of deposit build-up. In long-term tests, that is, storage of samples at room temperature for at least 100 days and during storage of samples in an atmosphere saturated with water vapor for a period of 28 days at 48° C., the migration process and the formation of white deposits are considerably accelerated and white deposits appear on the surface of the samples also in the case of the aforementioned TPUs, the deposits resulting in a marked change in color and matting of the samples. For most applications, this is undesirable in the highest degree because the substances plating out on the surface as a white deposit can be removed only with difficulty or not at all.

Furthermore, European Patent Application EP-A 1 149 851 describes thermoplastic polyurethanes which are composed of hexamethylene diisocyanate or a mixture with other diisocyanates, polytetramethylene glycol or a mixture with other polyols having molecular weights of 600 to 5000 g/mol, and 1,6-hexanediol or a mixture with other chain extenders having molecular weights of 60 to 500 g/mol, and which exhibit only a small amount of deposit build-up under the conditions specified there.

### BRIEF SUMMARY OF THE INVENTION

An object of the present invention is to specify a thermoplastically processable polyurethane molding material which, under long-term storage conditions or in humidity aging tests, exhibits no or only very small traces of substances (by-products or auxiliary agents) on its surface that are capable of migrating.

This objective may be achieved according to the present invention by the generically specified thermoplastically processable polyurethane molding material which is composed of a mixture (blend) of at least two thermoplastic polyurethanes, with at least 5 percent by weight, as a component A, being composed of a thermoplastic polyurethane which is obtained by reacting one or a plurality of aliphatic polyols which have a molecular weight of 800 to 4000 g/mol and a hydroxyl number of 20 to 235 and which are selected from the group of polyadipates, polycaprolactones, polycarbonates, polytetrahydrofurans and corresponding copolymers or mixtures thereof with 1,6-hexamethylene diisocyanate (HDI) and the chain-extending agent 1,6-hexanediol in an equivalent ratio of the 1,6-hexamethylene diisocyanate to the polyol of 1.5:1 to 14.0:1, the NCO index formed from the quotient, which is multiplied by 100, of the equivalent ratios of isocyanate groups to the sum of the hydroxyl groups of polyol and chain-extending agent lying within a range of 96 to 105, and 100 percent by weight of the rest, as a component B, being composed of one or a plurality of further thermoplastic polyurethanes which is obtained by reacting one or a plurality of aliphatic polyols which have a molecular weight of 800 to 4000 g/mol and a hydroxyl number of 20 to 235 and which are selected from the group of polyadipates, polycaprolactones, polycarbonates, polytetrahydrofurans and corresponding copolymers or mixtures thereof with the diisocyanates: 1,6-hexamethylene diisocyanate, isophorone diisocyanate, dicyclohexylmethane diisocyanate, diphenylmethane diisocyanate and a chain-extending agent selected from the group of 1,4- butanediol, 1,5 pentanediol, 1,4-cyclohexanediol, bis(hydroxymethyl)cyclohexane, bis(hydroxyethyl)hydroquinone, polycaprolactone having a number average molecular weight of 350 to 600 g/mol and polytetrahydrofuran having a number average molecular weight of 200 to 600 g/mol in an equivalent ratio of the diisocyanate to the polyol of 1.5:1 to 14.0:1, the NCO index formed from the quotient, which is multiplied by 100, of the equivalent ratios of isocyanate groups to the sum of the hydroxyl groups of polyol and chain-extending agent lying within a range of 96 to 105.

The thermoplastic polyurethane molding material according to the present invention preferably contains up to 40 percent by weight of component A in the mixture.

Particularly preferred is a thermoplastic polyurethane molding material where the mixture is composed of polyurethanes which are made of the constituents polycarbonate diol and/or polyadipate diol, hexamethylene diisocyanate and 1,6-hexanediol as a component A, and polycarbonate diol and/or polyadipate diol, hexamethylene diisocyanate and 1,4-cyclohexanediol and/or bis(hydroxymethyl)-cyclohexane as a component B.

The thermoplastic polyurethane molding material preferably contains, as additives, 0.1 to 3 percent by weight of a UV-light absorber, 0.1 to 5 percent by weight of a light stabilizer, 0.05 to 2 percent by weight of an antioxidant and, optionally, up to 10 percent by weight of a color pigment or color batch in relation to the total quantity of polyurethane, respectively.

The method according to the present invention for manufacturing a thermoplastic polyurethane molding material is carried out in such a manner that the starting polyurethanes are manufactured separately and processed into the polyurethane material in an extruder or kneader.

The additives are preferably also worked into the polyurethane material in one step.

According to the present invention, the thermoplastic polyurethane molding material is used as a sinterable powder for manufacturing sheet materials and molded bodies.

Ultimately, the present invention relates of molded bodies which are obtained from the thermoplastic polyurethane mixture according to the present invention.

Surprisingly, it was discovered that the manufacture of the thermoplastic polyurethane mixtures according to the present invention exhibits an extremely small amount of white deposit build-up under the conditions of long-term storage for a period of at least 100 days at room temperature or storage in an atmosphere saturated with water vapor for a period of at least 28 days at 48° C.

The polyurethane mixtures obtainable according to the present invention do not have any mechanical or processing disadvantages over the known aliphatic thermoplastically processable polyurethane molding materials, as is shown by the examples given below. The crystallization behavior for an economical manufacturing process is not much influenced either. Moreover, the mixtures have the following advantages:

good processability in thermoplastic manufacturing processes, such as injection molding, melt extrusion, melt spinning methods, sintering methods, hot-melt adhesive methods,

good crystallization behavior, in particular, fast recrystallization for an economical manufacturing process in the aforementioned methods,

tensile strength, tear initiation strength, and tear propagation strength, and

good elastic properties.

The present invention is explained in greater detail by the examples below. The TPUs according to the present invention, which are based on different chain extenders and diisocyanates (component A: hexanediol and HDI as well as component B: selection from the group of chain extenders and diisocyanates specified above), have to be manufactured in separate reaction processes. This can be carried out in known manner in a batch process or in a reaction extruder, preferably with the addition of a catalyst. Subsequently, the TPUs are compounded in a parts-by-weight ratio of TPU-component A/TPU-component B of 95/5 to 5/95, preferably 95/5 to 40/60, adding usual processing aids and additives, such as light-stabilizers, UV-absorbers, antioxidants, internal antiblocking agents and release agents, dyes and pigments, and, if required, hydrolysis stabilizers. This can be accomplished, for example, using an extruder or kneader.

Surprisingly, it was discovered that by combining the aliphatic TPU mixture based on HDI and the chain lengthening by hexanediol (TPU component A) even with small quantities of 5 parts by weight of a TPU having the same polyol base and a diisocyanate as well as a chain extender from the group of TPU component B, molded TPU bodies are yielded which exhibit only a very small amount of or no deposit build-up after storage at room temperature or even at elevated temperature in a warm, moist climate.

Moreover, the advantageous melting properties of the TPU based on HDI and the chain lengthening by hexanediol, component A, such as fusion behavior, melt viscosity, and fast crystallization are substantially maintained also when combining the TPU component A with the TPU components B. These are required properties for a good thermoplastic processing in injection molding, extrusion and, in particular, for the sintering process.

In addition to the reduction of the formation of deposits, further properties of the aliphatic TPUs are also markedly improved by special combinations of TPU component A with TPU components B. In particular, the dimensional stability under heat and the abrasion resistance of the TPUs can be improved. This brings further advantages, for example, for surface materials used in the interior of motor vehicles. The grain stability and scratch resistance of surface materials of TPU component A is indeed sufficient at room temperature, but at elevated temperature, the requirement of the automotive industry is not met. This problem can be solved using the TPUs according to the present invention. The hardness of the surface materials can also be influenced using the TPUs according to the present invention without causing serious disadvantages for the further properties. Thus, for example, a soft, leather-like feel of a dashboard skin can be achieved more easily by the combination of two TPUs having different compositions than with a TPU which has a uniform composition and in the case of which disadvantages, such as in the processing behavior, the temperature stability, and the strength properties, have to be accepted due to a shift in hardness.

TPUs, where the TPU raw material components of TPU component A and TPU component B are premixed and the TPU synthesis is carried out in one joint operation, exhibit a property profile which clearly differs from the combinations of the TPUs of component A and component B that are different in composition and manufactured separately. With these systems, no significant improvement is made with respect to white deposits. The processability, dimensional stability under heat, strength properties, and the abrasion behavior are also clearly worse compared to the TPU combinations of a comparable selection of raw materials.

### DETAILED DESCRIPTION

### EXAMPLES

The following are the composition of the TPU components for compounding according to the present invention:

| | Polyol | | Diisocyanate | | Chain extender | |
|---|---|---|---|---|---|---|
| TPU | Type | pbw/mol | Type | pbw/mol | Type | pbw/mol |
| component | Polycarbonate diol | 100/0.05 | hexamethylene | 30/0.178 | 1,6-hexanediol | 15.57/0.132 |
| A1 | | | diisocyanate | | | |
| component | hexanediol/neopentyl | 100/0.05 | hexamethylene | 40/0.238 | 1,6-hexanediol | 23.06/0.195 |
| A2 | glycol adipate | | diisocyanate | | | |
| component | polycarbonate diol | 100/0.05 | hexamethylene | 35/0.208 | 1,4- | 18.99/0.164 |
| B1 | | | diisocyanate | | cyclohexanediol | |
| component | polycarbonate diol | 100/0.05 | hexamethylene | 40/0.238 | bis(hydroxymethyl)- | 27.96/0.194 |
| B2 | | | diisocyanate | | cyclohexane | |
| component | hexanediol/neopentyl | 100/0.05 | dicyclohexylmethane | 50/0.191 | 1,4-butanediol | 13.05/0.145 |
| B3 | glycol adipate | | diisocyanate | | | |
| component | hexanediol/neopentyl | 100/0.05 | diphenylmethane | 50/0.200 | 1,4-butanediol | 13.86/0.154 |
| B4 | glycol adipate | | diisocyanate | | | |

### Comparison Example

The comparison example is a TPU copolymer where the TPU raw material components of TPU component A and TPU component B are premixed and the TPU synthesized in one operation.

| | Polyol | | Diisocyanate | | Chain extender | |
|---|---|---|---|---|---|---|
| TPU | Type | pbw/mol | Type | pbw/mol | Type | Pbw/mol |
| comparison | polycarbonate diol | 70/0.035 | hexamethylene | 40/0.238 | 1,6-hexanediol | 16.05/0.136 |
| 1 | hexanediol/neopentyl | 30/0.015 | diisocyanate | | bis(hydroxymethyl) | 8.42/0.058 |
| | glycol adipate | | | | cyclohexane | |

The manufacture of the TPU was carried out in a batch process. The polyol, chain extender, and diisocyanate were heated in a reaction vessel under agitation and poured at a temperature of 200° C. to form a plate. After a storage period of 24 h at room temperature, the plate was processed into a granular material.

The composition of the TPU compounds (combinations) according to the present invention are as follows:

TPU compound 1:95 parts by weight of TPU A1+5 parts by weight of TPU B1

TPU compound 2:80 parts by weight of TPU A1+20 parts by weight of TPU B1

TPU compound 3:70 parts by weight of TPU A1+30 parts by weight of TPU B2

TPU compound 4:75 parts by weight of TPU A2+25 parts by weight of TPU B3

TPU compound 5:85 parts by weight of TPU A2+15 parts by weight of TPU B4

All TPU compounds were mixed with 0.4 percent by weight of a light stabilizer (Chimassorb 944 from the Ciba Company), 0.4 percent by weight of a UV-absorber (Tinuvin 328 from the Ciba Company), 0.25 percent by weight of an antioxidant (Irganox 245 from the Ciba Company) and 2 percent by weight of a batch of black dye based on a carbon black. In addition, a carbodiimide, Stabaxol P200 (hydrolysis stabilizer), was added to TPU compounds 4 and 5. The compounding of the TPU and the additives into a homogenous material was carried out in a twin-screw extruder.

The checking of the TPU for white deposits proceeded as follows:

Injection-molded plates were made from the TPU compounds and subsequently checked for white deposits under the following storage conditions:

Formation of deposits upon storage at room temperature (18 to 25° C.) for:

| TPU | 4 weeks | 8 weeks | 12 weeks |
|---|---|---|---|
| component A1 | Low | marked | marked |
| component A2 | Low | marked | marked |
| compound 1 | None | none | very low |
| compound 2 | None | none | none |
| compound 3 | None | none | none |
| compound 4 | None | none | none |
| compound 5 | None | none | none |
| comparison | None | very low | low |
| example 1 | | | |

Formation of deposits upon storage in an atmosphere saturated with water vapor at 48° C. for:

| TPU | 7 days | 14 days | 28 days |
|---|---|---|---|
| component A1 | Low | marked | strong |
| component A2 | Low | marked | strong |
| compound 1 | None | very low | low |
| compound 2 | none | none | very low |
| compound 3 | none | none | none |
| compound 4 | none | none | none |
| compound 5 | none | none | very low |
| comparison | very low | low | low |
| example 1 | | | |

A quick test to check for the formation of deposits was performed as follows:

Formation of deposits upon storage in water at 40° C. for:

| TPU | 2 days | 3 days | 4 days |
|---|---|---|---|
| component A1 | low | marked | strong |
| component A2 | low | marked | strong |
| compound 1 | none | none | low |
| compound 2 | none | none | very low |
| compound 3 | none | none | none |
| compound 4 | none | none | none |
| compound 5 | none | none | very low |
| comparison | none | low | marked |
| example 1 | | | |

Testing of the processability of the TPU in the powder sintering method for the manufacture of surface materials for the interior of motor vehicles as well as the property profile of the sintered films was performed as follows:

Test results of the relevant properties for evaluating the processability in the powder sintering method:

| | | Processing | Ease of | Susceptibility to |
|---|---|---|---|---|
| TPU | Fusion behavior | temperature | demolding | buckling |
| component A1 | fast for short cycle | 200-220° C. | good, fast | High |
| | times | | recrystallization | |
| component A2 | sufficiently fast for | 200-220° C. | good, fast | High |
| | short cycle times | | recrystallization | |
| comparison | fast fusion | 190-220° C. | insufficient, slow | evaluation not |
| example 1 | | | recrystallization, | possible due to a |
| | | | distortion-free | high degree of |
| | | | demolding not | distortion |
| | | | possible | |
| compound 2 | fast for short cycle | 200-220° C. | good, fast | Low |
| | times | | recrystallization | |
| compound 3 | fast for short cycle | 200-220° C. | good, fast | Low |
| | times | | recrystallization | |
| compound 4 | fast for short cycle | 200-220° C. | good, fast | Low |
| | times | | recrystallization | |

Results of the testing of sintered films:

| | | | | Dimensional |
|---|---|---|---|---|
| | | | | stability under heat, |
| | | | | grain stability |
| | Hardness | Tactile | | after 240 h sun |
| TPU | Shore A | properties | Melting range ° C. | simulation at 120° C. |
| component A1 | 92 | plastic-like feel | 155-160 | small change in the |
| | | | | degree of gloss due to |
| | | | | fusing of the grain |
| | | | | tops |
| component A2 | 90 | plastic-like feel | 155-160 | small change in the |
| | | | | degree of gloss due to |
| | | | | fusing of the grain |
| | | | | tops |
| comparison | 86 | leather-like feel | 130-135 | significant increase in |
| example 1 | | | | gloss, complete fusing |
| | | | | of the grain structure |
| compound 2 | 86 | leather-like feel | 170-175 | no change in the |
| | | | | degree of gloss, |
| | | | | unchanged |
| | | | | appearance of the |
| | | | | grain |
| compound 3 | 87 | leather-like feel | 165-170 | no change in the |
| | | | | degree of gloss, |
| | | | | unchanged |
| | | | | appearance of the |
| | | | | grain |
| compound 4 | 84 | leather-like feel | 160-165 | no change in the |
| | | | | degree of gloss, |
| | | | | unchanged |
| | | | | appearance of the |
| | | | | grain |

Testing of the grain stability during sun simulation: 240 h endurance test according to DIN 75 220 at 120° C.

| | | | | Abrasion resistance |
|---|---|---|---|---|
| | | | | Crockmeter test |
| | | | Scratch resistance | A: dry |
| | | Elongation at | Veslic method | B: window cleaner |
| | Tensile strength | break | Rating 0-5 | C: isopropanol |
| | DIN EN 527 | DIN EN 527 | Fingernail test for | D: benzine |
| TPU | (Mpa) | (%) | writing marks | Rating 5-1 |
| component A1 | 38 | 620 | Veslic: 2 | A: 4 |
| | | | no writing marks | B: 4 |
| | | | | C: 4 |
| | | | | D: 3 |
| component A2 | 41 | 510 | Veslic: 2 | A: 4 |
| | | | no writing marks | B: 5 |
| | | | | C: 4 |
| | | | | D: 4 |
| comparison | 19 | 305 | Veslic: 5 | A: 3 |
| example 1 | | | heavy writing marks | B: 3 |
| | | | | C: 2 |
| | | | | D: 1 |
| compound 2 | 36 | 585 | Veslic: 1 | A: 5 |
| | | | no writing marks | B: 5 |
| | | | | C: 4 |
| | | | | D: 4 |
| compound 3 | 40 | 560 | Veslic: 0 | A: 5 |
| | | | no writing marks | B: 5 |
| | | | | C: 5 |
| | | | | D: 5 |
| compound 4 | 37 | 525 | Veslic: 0 | A: 5 |
| | | | no writing marks | B: 5 |
| | | | | C: 5 |
| | | | | D: 5 |

The Veslic method occurs as follows: a plastic disk having a Shore D hardness of 85 rotates on the test piece at a contact pressure of 15N and a speed of 15 cm/s (Rating of the surface: 0=unchanged, 5=very much changed). Veslic stands for the Association of Swiss Leather Chemists and Technologists.

The Crockmeter test is a test according to DIN 54 021. Dry rubbing fabric (1oo Crockmeter strokes). Rubbing fabric soaked wit cleaning agent (10 Crockmeter strokes). The gray scale rating is as follows: 5=good, 1=poor.

What is claimed is:

1. A thermoplastically processable polyurethane molding material comprising:
a mixture of at least one first thermoplastic polyurethane defining a component A and at least one second thermoplastic polyurethane defining a component B,
the component A being at least 5 percent by weight of the mixture and being obtained by reacting at least one of a first aliphatic polyol having a molecular weight of 800 to 4000 g/mol and a hydroxyl number of 20 to 235 and being selected from the group consisting of polyadipates, polycaprolactones, polycarbonates, polytetrahydrofurans and corresponding copolymers or mixtures thereof with 1,6-hexamethylene diisocyanate and a first chain-extending agent 1,6-hexanediol in an equivalent ratio of the 1,6-hexamethylene diisocyanate to the polyol of 1.5:1 to 14.0:1, a first NCO index equal to a quotient of an equivalent ratio of isocyanate groups to the sum of the hydroxyl groups of the first aliphatic polyol and the first chain-extending agent, multiplied by a 100, lying within a range of 96 to 105,
the component B being obtained by reacting at least one second aliphatic polyol having a molecular weight of 800 to 4000 g/mol and a hydroxyl number of 20 to 235 and being selected from the group consisting of polyadipates, polycaprolactones, polycarbonates, polytetrahydrofurans and corresponding copolymers or mixtures thereof with at least one diisocyanate selected from the group consisting of 1,6-hexamethylene diisocyanate, isophorone diisocyanate, dicyclohexylmethane diisocyanate and diphenylmethane diisocyanate and a second chain-extending agent selected from the group consisting of 1,4-butanediol, 1,5 pentanediol, 1,4-cyclohexanediol, bis(hydroxymethyl)cyclohexane, bis(hydroxyethyl)hydroquinone, polycaprolactone having a number average molecular weight of 350 to 600 g/mol and polytetrahydrofuran having a number average molecular weight of 200 to 600 g/mol in an equivalent ratio of the diisocyanate to the polyol of 1.5:1 to 14.0:1, a second NCO index equal to a quotient of an equivalent ratio of isocyanate groups to the sum of the hydroxyl groups, multiplied by 100, of the second aliphatic polyol and the second chain-extending agent lying within a range of 96 to 105.

2. The thermoplastic polyurethane molding material as recited in claim 1 wherein the mixture contains up to 40 percent by weight of the component A.

3. The thermoplastic polyurethane molding material as recited in claim 1 wherein component A includes polycarbonate diol and/or polyadipate diol, hexamethylene diisocyanate and 1,6-hexanediol and component B includes polycarbonate diol and/or polyadipate diol, hexamethylene diisocyanate and 1,4-cyclohexanediol and/or bis(hydroxymethyl)-cyclohexane.

4. The thermoplastic polyurethane molding material as recited in claim 1 wherein the mixture further includes 0.1 to 3 percent by weight of a UV-light absorber, 0.1 to 5 percent by weight of a light stabilizer and 0.05 to 2 percent by weight of an antioxidant in relation to the total quantity of polyurethane.

5. The thermoplastic polyurethane molding material as recited in claim 4 wherein the mixture further includes up to 10 percent by weight of a color pigment or color batch in relation to the total quantity of polyurethane.

6. A method of manufacturing a thermoplastic polyurethane molding material, comprising:
mixing in an extruder or kneader at least one first thermoplastic polyurethane defining a component A and at least one second thermoplastic polyurethane defining a component B so as to form a mixture,
the component A being at least 5 percent by weight of the mixture and being obtained by reacting at least one of a first aliphatic polyol having a molecular weight of 800 to 4000 g/mol and a hydroxyl number of 20 to 235 and being selected from the group consisting of polyadipates, polycaprolactones, polycarbonates, polytetrahydrofurans and corresponding copolymers or mixtures thereof with 1,6-hexamethylene diisocyanate and a first chain-extending agent 1,6-hexanediol in an equivalent ratio of the 1,6-hexamethylene diisocyanate to the polyol of 1.5:1 to 14.0:1, a first NCO index equal to a quotient of an equivalent ratio of isocyanate groups to the sum of the hydroxyl groups of the first aliphatic polyol and the first chain-extending agent, multiplied by a 100, lying within a range of 96 to 105,
the component B being obtained by reacting at least one second aliphatic polyol having a molecular weight of 800 to 4000 g/mol and a hydroxyl number of 20 to 235 and being selected from the group consisting of polyadipates, polycaprolactones, polycarbonates, polytetrahydrofurans and corresponding copolymers or mixtures thereof with at least one diisocyanate selected from the group consisting of 1,6-hexamethylene diisocyanate, isophorone diisocyanate, dicyclohexylmethane diisocyanate and diphenylmethane diisocyanate and a second chain-extending agent selected from the group consisting of 1,4-butanediol, 1,5 pentanediol, 1,4-cyclohexanediol, bis(hydroxymethyl)cyclohexane, bis(hydroxyethyl)hydroquinone, polycaprolactone having a number average molecular weight of 350 to 600 g/mol and polytetrahydrofuran having a number average molecular weight of 200 to 600 g/mol in an equivalent ratio of the diisocyanate to the polyol of 1.5:1 to 14.0:1, a second NCO index equal to a quotient of an equivalent ratio of isocyanate groups to the sum of the hydroxyl groups, multiplied by 100, of the second aliphatic polyol and the second chain-extending agent lying within a range of 96 to 105.

7. The method as recited in claim 6 further comprising adding additives into the mixture.

8. The method as recited in claim 6 wherein the mixture forms a sinterable powder and further comprising manufacturing sheet materials and molded bodies from the sinterable powder.

9. A molded body comprising:
a mixture of at least one first thermoplastic polyurethane defining a component A and at least one second thermoplastic polyurethane defining a component B,
the component A being at least 5 percent by weight of the mixture and being obtained by reacting at least one of a first aliphatic polyol having a molecular weight of 800 to 4000 g/mol and a hydroxyl number of 20 to 235 and being selected from the group consisting of polyadipates, polycaprolactones, polycarbonates, polytetrahydrofurans and corresponding copolymers or mixtures thereof with 1,6-hexamethylene diisocyanate and a first chain-extending agent 1,6-hexanediol in an equivalent ratio of the 1,6-hexamethylene diisocyanate to the polyol of 1.5:1 to 14.0:1, a first NCO index equal to a quotient of an equivalent ratio of isocyanate groups to the sum of the hydroxyl groups of the first aliphatic polyol and the first chain-extending agent, multiplied by a 100, lying within a range of 96 to 105,
the component B being obtained by reacting at least one second aliphatic polyol having a molecular weight of 800 to 4000 g/mol and a hydroxyl number of 20 to 235 and being selected from the group consisting of polyadipates, polycaprolactones, polycarbonates, polytetrahydrofurans and corresponding copolymers or mixtures thereof with at least one diisocyanate selected from the group consisting of 1,6-hexamethylene diisocyanate, isophorone diisocyanate, dicyclohexylmethane diiusocyanate and diphenylmethane diisocyanate and a second chain-extending agent selected from the group consisting of 1,4-butanediol, 1,5 pentanediol, 1,4-cyclohexanediol, bis(hydroxymethyl)cyclohexane, bis(hydroxyethyl)hydroquinone, polycaprolactone having a number average molecular weight of 350 to 600 g/mol and polytetrahydrofuran having a number average molecular weight of 200 to 600 g/mol in an equivalent ratio of the diisocyanate to the polyol of 1.5:1 to 14.0:1, a second NCO index equal to a quotient of an equivalent ratio of isocyanate groups to the sum of the hydroxyl groups, multiplied by 100, of the second aliphatic polyol and the second chain-extending agent lying within a range of 96 to 105.
